(19) United States
(12) Patent Application Publication
(10) Pub. No.: US 2016/0244099 A1
(43) Pub. Date: Aug. 25, 2016

(54) VEHICLE UPPER SECTION STRUCTURE

(71) Applicant: TOYOTA JIDOSHA KABUSHIKI KAISHA, Toyota-shi (JP)

(72) Inventors: Takuya OSHIMA, Okazaki-shi (JP); Takuya YABE, Toyota-shi (JP); Hideyuki YOSHIOKA, Okazaki-shi (JP)

(73) Assignee: TOYOTA JIDOSHA KABUSHIKI KAISHA, Toyota-shi (JP)

(21) Appl. No.: 14/952,257

(22) Filed: Nov. 25, 2015

(30) Foreign Application Priority Data
Feb. 20, 2015 (JP) 2015-032224

(51) Int. Cl. B62D 21/15; B62D 25/04

(52) U.S. Cl. CPC B62D 21/157; B62D 25/04

(57) ABSTRACT

A vehicle upper section structure for a vehicle having a roof panel formed with an opening, a roof side rail, a cover member for the opening, and a pillar joined to the roof side rail, the vehicle upper section structure including: a frame that extends along a vehicle width direction further to an inside than the roof panel and the roof side rail; a movement section that is disposed at a vehicle width direction end portion of the frame and further to an upper side than the frame, and that moves the cover member; a roof reinforcement that extends along the vehicle width direction further to an upper side than the frame and the movement section, and that reinforces the roof panel; and a section that couples together the frame and the roof reinforcement in the vehicle up-down direction, further to the vehicle width direction inside than the movement section.

### CROSS-REFERENCE TO RELATED APPLICATION

This application claims priority under 35 USC 119 from Japanese Patent Application, No. 2015-032224, filed Feb. 20, 2015, the disclosure of which is incorporated by reference herein.

### BACKGROUND

1. Technical Field

The present invention relates to a vehicle upper section structure.

2. Related Art

Japanese Patent Application Laid-Open (JP-A) No. 2010-188797 describes a vehicle upper section structure including a sunroof frame extending along the vehicle width direction between a pair of side rails, and sunroof reinforcement that is superimposed on the sunroof frame from the vehicle up-down direction lower side and spot welded thereto. In the vehicle upper section structure of JP-A No. 2010-188797, a sunroof assembly including an open/close mechanism that opens and closes a lid (a cover member) of a sunroof is disposed further to the vehicle up-down direction lower side than the sunroof reinforcement. In other words, the vehicle upper section structure of JP-A No. 2010-188797 may be said to be a structure in which there is no sunroof open/close mechanism between the sunroof frame and the sunroof reinforcement.

### SUMMARY

However, in the above related art, in cases in which another frame is disposed at the vehicle up-down direction lower side of the sunroof assembly, load, that is imparted to the side rail in a collision at a vehicle side face (in a side-on collision), is transmitted to this frame. In a structure in which a frame is disposed further to the vehicle up-down direction lower side than the sunroof assembly in this manner, it is difficult to distribute load from the frame to other members in a side-on collision.

There is accordingly room for improvement in order to suppress the vehicle upper section from deforming.

In consideration of the above circumstances, the present invention obtains a vehicle upper section structure capable of suppressing a vehicle upper section from deforming in a side-on collision, in vehicles in which a cover member is moved by a movement section so as to open and close an opening of a roof panel.

A vehicle upper section structure for a vehicle, that has a roof panel formed with an opening, a roof side rail, a cover member for closing the opening, and a pillar joined to the roof side rail, of a first aspect of the present invention includes: a frame that extends along a vehicle width direction further to a vehicle cabin inside than a roof panel formed with an opening, and further to the vehicle cabin inside than a roof side rail; a movement section that is disposed at a vehicle width direction end portion of the frame and further to a vehicle up-down direction upper side than the frame, and that moves a cover member for closing the opening to an open position and to a closed position; a roof reinforcement that extends along the vehicle width direction further to the vehicle up-down direction upper side than the frame and the movement section, and that reinforces the roof panel; and a coupling section that couples together the frame and the roof reinforcement in the vehicle up-down direction, further to the vehicle width direction inside than the movement section.

In the vehicle upper section structure of the first aspect, the frame and the roof reinforcement are coupled together in the vehicle up-down direction by the coupling section, further to the vehicle width direction inside than the movement section. Thus, when load that is input to the vehicle upper section structure in a side-on collision is transmitted to the frame and the roof reinforcement, load is transmitted from one to the other of the frame and the roof reinforcement through the coupling section.

Namely, the input load is distributed and transmitted to the frame and the roof reinforcement, thereby suppressing the load from localized concentration at a portion of the vehicle upper section. Thus the frame and the roof reinforcement are suppressed from deforming, thereby enabling the vehicle upper section, in which the cover member moved by the movement section opens and closes the opening of the roof panel, to be suppressed from deforming in a side-on collision in vehicles.

In a vehicle upper section structure of a second aspect of the present invention, the coupling section includes a bracket that joins together a vehicle up-down direction upper face of the frame and a vehicle up-down direction lower face of the roof reinforcement.

In the vehicle upper section structure of the second aspect, the frame and the roof reinforcement are joined together by the bracket, such that there is no need to bring the frame and the roof reinforcement close to each other in order to join these members together. Namely, there is no need to curve or bend at least one of the frame or the roof reinforcement in order to bring these members together, thereby enabling the frame and the roof reinforcement to be formed in straight lines running along the vehicle width direction. This enables the frame and the roof reinforcement to be suppressed from deforming, since a curved or bent location that would become a weakened portion during load transmission is suppressed from being formation.

In a vehicle upper section structure of a third aspect of the present invention, the bracket includes a main body section that is open toward the vehicle width direction and is joined to the frame, and a flange portion that juts out in the vehicle front-rear direction from the main body section and is joined to the roof reinforcement.

In the vehicle upper section structure of the third aspect, a ridgeline, that forms a boundary between the main body section and the flange portion of the bracket, is disposed substantially along a vehicle width direction that is a transmission direction of load input to the vehicle upper section structure in a side-on collision. Thus load is transmitted in the ridgeline direction where the bracket is not liable to deform, thereby enabling the bracket, the frame, and the roof reinforcement to be suppressed from deforming.

In a vehicle upper section structure of a fourth aspect of the present invention, viewed along the vehicle width direction, at least a portion of the frame in the vehicle front-rear direction is disposed at an upper side in a vehicle up-down direction upper end portion of a pillar joined to the roof side rail.

In the vehicle upper section structure of the fourth aspect, a load transmission path from the pillar to the frame is shorter than in a structure in which the frame is not disposed at an upper side of the pillar as viewed along the vehicle width direction. Load transmission efficiency from the pillar to the frame in a side-on collision is accordingly improved, thereby enabling an intrusion amount of the pillar toward the vehicle cabin inside in a side-on collision to be reduced.

### Advantageous Effects of Invention

As explained above, the vehicle upper section structure of the first aspect enables the vehicle upper section to be suppressed from deforming in a side-on collision, in vehicles in which the cover member moved by the movement section opens and closes the opening of the roof panel.

The vehicle upper section structure of the second aspect enables the frame and the roof reinforcement to be suppressed from deforming.

The vehicle upper section structure of the third aspect enables the bracket, the frame and the roof reinforcement to be suppressed from deforming.

The vehicle upper section structure of the fourth aspect enables the intrusion amount of the pillar toward the vehicle cabin inside in a side-on collision to be reduced.

### BRIEF DESCRIPTION OF THE DRAWINGS

Embodiments of the present invention will be described in detail based on the following figures, wherein:

FIG. 1 is a perspective view illustrating an upper section of a vehicle applied with a vehicle upper section structure according to a first exemplary embodiment;

FIG. 2 is an enlarged cross-section sectioned along line 2-2 in FIG. 1;

FIG. 3 is a perspective view of a vehicle upper section structure according to the first exemplary embodiment, viewed from a vehicle cabin inside;

FIG. 4 is an enlarged cross-section of relevant portions of a vehicle upper section structure according to the first exemplary embodiment, viewed along the vehicle width direction;

FIG. 5 is an explanatory drawing illustrating placement of a center pillar, a center frame, and roof reinforcement according to the first exemplary embodiment;

FIG. 6 is an explanatory drawing illustrating a load transmission state in a side-on collision of a vehicle upper section structure according to the first exemplary embodiment; and

FIG. 7 is an enlarged cross-section of relevant portions of a vehicle upper section structure according to a second exemplary embodiment, viewed along the vehicle width direction.

### DETAILED DESCRIPTION OF THE INVENTION

### First Exemplary Embodiment

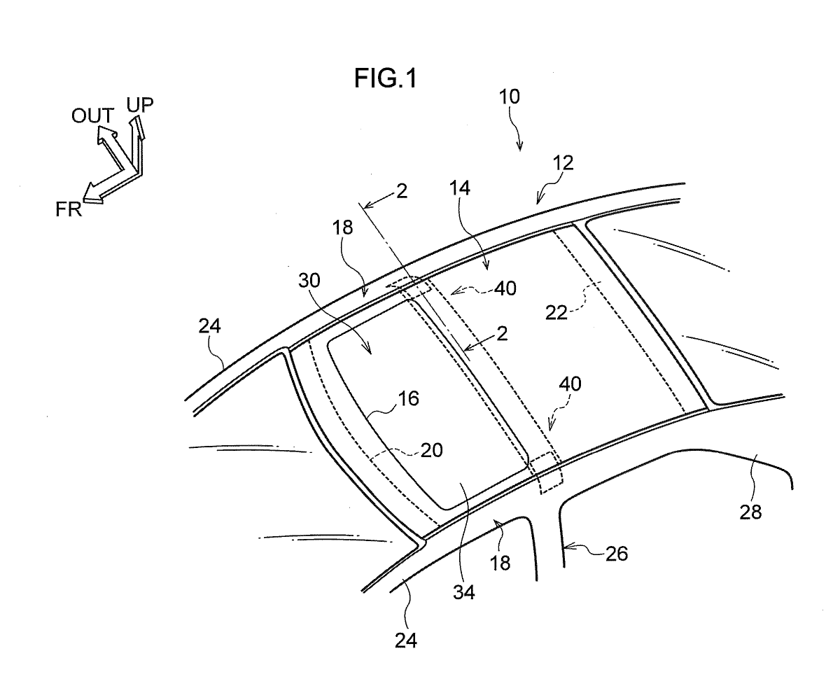

Explanation follows regarding a first exemplary embodiment of a vehicle upper section structure according to the present invention, with reference to FIG. 1 to FIG. 6. Note that in each of the drawings, the arrow FR indicates the vehicle front side, the arrow RR indicates the vehicle rear side, the arrow UP indicates the vehicle upper side, the arrow IN indicates the vehicle width direction inside, and the arrow OUT indicates the vehicle width direction outside, as appropriate. In the below explanation, unless specifically stated otherwise, simple reference to the front-rear, up-down, and left-right directions refers to front-rear in the vehicle front-rear direction, up-down in the vehicle up-down direction, and left-right in the vehicle width direction when facing the vehicle front side. The x mark in the drawings indicates a spot welded location.

Overall Configuration of Vehicle

FIG. 1 illustrates a vehicle 10 according to a first exemplary embodiment. A roof panel 14 is provided at a vehicle upper section 12 of the vehicle 10. The roof panel 14 is a metal panel member configuring an outer panel of the roof of the vehicle 10. The roof panel 14 is disposed running along the vehicle front-rear direction and vehicle width direction.

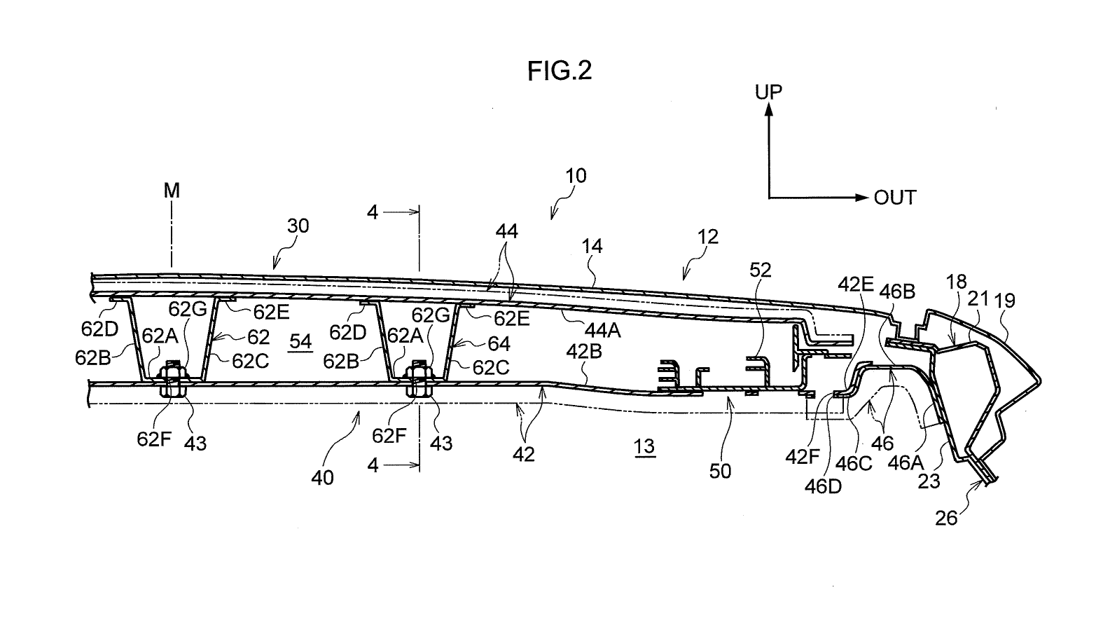

An opening 16 that pierces through in the vehicle up-down direction is formed further to the front side than a vehicle front-rear direction center portion of the roof panel 14. Roof side rails 18 that extend along the vehicle front-rear direction are respectively provided at both vehicle width direction sides of the roof panel 14. As illustrated in FIG. 2, side outer panels 19 are provided at the vehicle width direction outsides of the roof side rails 18. Note that the side outer panels 19 are not illustrated in FIG. 1. A sunroof unit 30 that opens and closes the opening 16 is also provided at the vehicle upper section 12.

A front header 20 running along the vehicle width direction spans across front end portions of the pair of roof side rails 18. Front pillars 24 extend toward the vehicle front and vehicle lower side from the front end portions of the roof side rails 18. A rear header 22 running along the vehicle width direction spans across rear end portions of the pair of roof side rails 18. Upper end portions of center pillars 26, each serving as an example of a pillar, are joined to vehicle front-rear direction center portions of the respective roof side rails 18. The center pillars 26 extend toward the vehicle lower side from the roof side rails 18. Rear pillars 28 extend toward the vehicle rear and vehicle lower side from the rear end portions of the roof side rails 18.

A lower end portion of the front pillar 24, a lower end portion of the center pillar 26, and a lower end portion of the rear pillar 28 are each joined to a rocker, not illustrated in the drawings, extending along the vehicle front-rear direction. The vehicle upper section 12 is also provided with a vehicle upper section structure 40, described later.

Roof Side Rails

As illustrated in FIG. 2, each roof side rail 18 is configured by a roof side rail outer panel 21 disposed at the outside of a vehicle cabin 13, and a roof side rail inner panel 23 disposed at the inner side of the roof side rail outer panel 21. An upper end portion of the roof side rail outer panel 21 is joined by welding to an upper end portion of the roof side rail inner panel 23. A lower end portion of the roof side rail outer panel 21 is joined by welding to a lower end portion of the roof side rail inner panel 23. The roof side rail 18 is thereby formed with a closed cross-section as viewed along the vehicle front-rear direction.

The lower end portion of the roof side rail outer panel 21 and the lower end portion of the roof side rail inner panel 23 are joined by welding to the upper end portion of the center pillar 26. In FIG. 2, each member positioned further to the vehicle front-rear direction front side than a location of line 2-2 in FIG. 1 is illustrated by a double-dotted dashed line.

Configuration of Relevant Portions

Explanation follows regarding the vehicle upper section structure 40.

As illustrated in FIG. 2, the vehicle upper section structure 40 includes a center frame 42 serving as an example of a frame, roof reinforcement 44, a movement section 50 provided at the sunroof unit 30, and coupling brackets 62, 64 serving as an example of a coupling section and of a bracket. Note that the vehicle upper section structure 40 has a similar structure on both sides of a center position M of the vehicle upper section 12 in the vehicle width direction (the position is illustrated by a single-dotted dashed line M). Illustration and explanation thereby follows regarding the vehicle upper section structure 40 at one vehicle width direction side (right side) and illustration and explanation of the other side (left side) is omitted.

Center Frame

As illustrated in FIG. 2, the center frame 42 extends along the vehicle width direction between the pair of roof side rails 18. The center frame 42 is formed in an elongated shape with its length direction along the vehicle width direction and its breadth direction along the vehicle front-rear direction. Namely, the center frame 42 extends along the vehicle width direction, further to inner side of the vehicle cabin 13 (hereafter referred to as “vehicle cabin inside”) than the roof panel 14, and further to inner side of the vehicle cabin than the roof side rails 18. The center frame 42 is disposed further to a lower side than the sunroof unit 30.

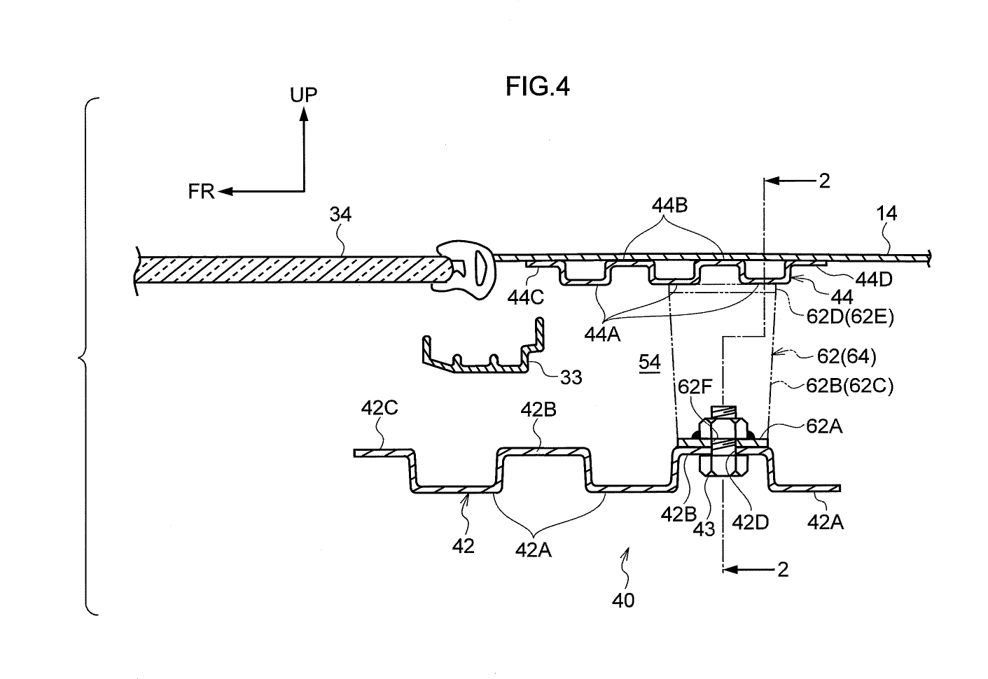

As illustrated in FIG. 4, the center frame 42 is configured with a cross-section profile along the vehicle front-rear direction that is formed in a rectangular waveform shape. Specifically, the center frame 42 includes three projecting portions 42A formed projecting toward the vehicle lower side with respect to an upper face, two flat portions 42B that link between the three projecting portions 42A along the vehicle front-rear direction, and a flange 42C jutting out toward the vehicle front side.

The three projecting portions 42A are disposed at intervals along the vehicle front-rear direction, and are each formed with a U-shaped cross-section in vehicle side view. However, the projecting portion 42A at the vehicle rear side does not have a side wall at the vehicle rear side, and is formed in a flange shape jutting out toward the vehicle rear side. The two flat portions 42B link between upper end portions of two adjacent projecting portions 42A and are disposed extending along the vehicle front-rear direction. Plural through-holes 42D, piercing through in the vehicle up-down direction at intervals along the vehicle width direction, are formed in the vehicle rear side flat portion 42B. The diameter of each through-hole 42D is of a size through which a shaft portion of a bolt 43 can be inserted. The flange 42C juts out toward the vehicle front side from an upper end portion of the vehicle front side projecting portion 42A.

As illustrated in FIG. 2, a bent portion 42E bent diagonally toward an upper side along the vehicle width direction is formed at a vehicle width direction end portion of the center frame 42. A through-hole 42F, piercing through in the vehicle up-down direction, is formed further to the vehicle width direction inside than the bent portion 42E of the center frame 42. Note that a weld nut, not illustrated in the drawings, is provided at a peripheral edge portion of the through-hole 42F at the upper face of the center frame 42. A location at which the through-hole 42F is formed and the bent portion 42E of the center frame 42 are joined by a bolt, not illustrated in the drawings, to the upper side of a vehicle width direction inside end portion of a sunroof bracket 46, described later.

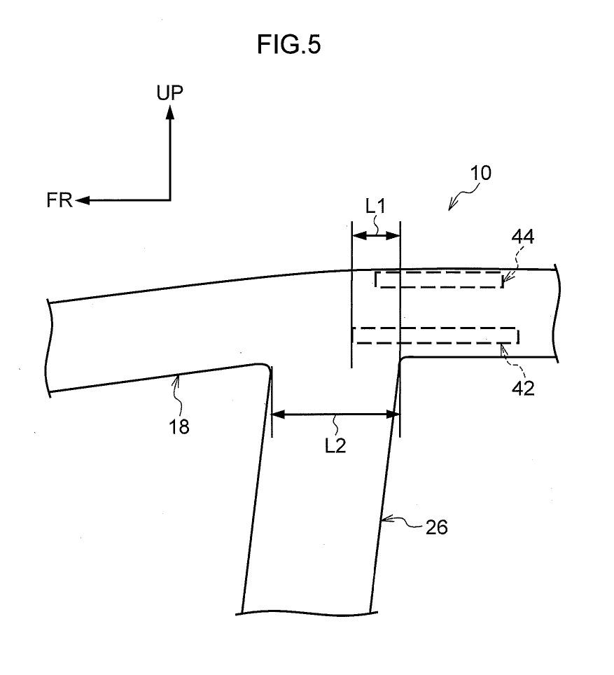

As illustrated in FIG. 5, when the vehicle 10 is viewed in the vehicle width direction, vehicle front-rear direction center portions of the center frame 42 and the roof reinforcement 44 are disposed offset further to the rear side than a vehicle front-rear direction center portion of the center pillar 26. This is in order to widen the opening 16 (see FIG. 1) along the vehicle front-rear direction.

As viewed in the vehicle width direction, a portion of the center frame 42a in the vehicle front-rear direction front side is disposed at an upper side of an upper end portion of the center pillar 26. In other words, as viewed in the vehicle width direction, a portion at the front side of the center frame 42, this being the portion with length L1 from a vehicle front-rear direction front end, extends further toward the front side than a rear end position of the upper end portion of the center pillar 26. In the present exemplary embodiment, L2>L1, where L2 is the vehicle front-rear direction length of the upper end portion of the center pillar 26.

Sunroof Bracket

As illustrated in FIG. 2, the sunroof bracket 46 includes a first joint portion 46A, a flat portion 46B, and a second joint portion 46C. The sunroof bracket 46 is formed with a rectangular waveform shaped cross-section profile running along the vehicle front-rear direction.

The first joint portion 46A is superimposed on a vehicle up-down direction center portion of the roof side rail inner panel 23 from the vehicle width direction inside, and joined thereto by welding. The flat portion 46B extends toward the vehicle width direction inside from an upper end portion of the first joint portion 46A. The second joint portion 46C bends diagonally toward a lower side along the vehicle width direction from a vehicle width direction inside end portion of the flat portion 46B, and is formed in a crank shape. A through-hole 46D, piercing through in the vehicle up-down direction, is formed at the second joint portion 46C. The vehicle width direction end portion of the center frame 42 is superimposed on the second joint portion 46C from the upper side, and joined thereto by the bolt, not illustrated in the drawings.

Sunroof Unit

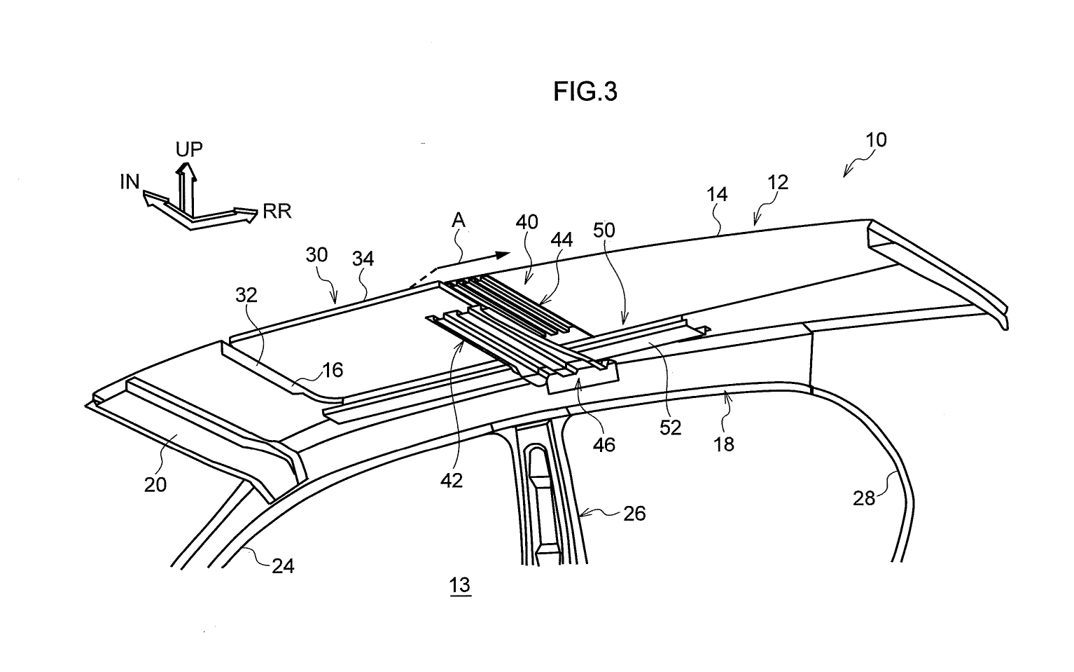

As illustrated in FIG. 3, the sunroof unit 30 is configured including a sunroof frame 32 configuring part of a unit main body, sliding glass 34 serving as an example of a cover member, and the movement section 50 that moves the sliding glass 34.

Sunroof Frame

The sunroof frame 32 configures an upper section frame at an upper side of the sunroof unit 30. The sunroof frame 32 is disposed further to a lower side than the roof panel 14, and surrounds the opening 16, as viewed in the vehicle up-down direction. A frame member 33 (see FIG. 4), configuring part of the sunroof unit 30, is provided further to a lower side than the sunroof frame 32.

Sliding glass

As viewed along the vehicle up-down direction, a sealing material, not illustrated in the drawings, is attached to an outer peripheral face of the sliding glass 34. The opening 16 is closed by disposing the sliding glass 34 in a closed position in which the sealing material is sandwiched between the sliding glass 34 and the sunroof frame 32. The opening 16 is opened by disposing the sliding glass 34 in an open position further to an upper side than the roof panel 14.

Movement Section

The movement section 50 is configured including a slide rail 52, and a roof motor, a slide section, and a link mechanism section, none of which are illustrated in the drawings. The movement section 50 moves the sliding glass 34 to the open position and the closed position described above.

The slide rail 52 is laid along the vehicle front-rear direction, further to the upper side than the vehicle width direction end portion of the center frame 42, and further to the lower side than a vehicle width direction outer end portion of the sunroof frame 32 and a vehicle width direction end portion of the roof reinforcement 44. The slide rail 52 extends along the vehicle front-rear direction across a range from a front end portion of the sunroof frame 32 to further to the rear side than the center frame 42. The slide rail 52 supports the slide section and the link mechanism section, not illustrated in the drawings, so as to allow movement thereof along the vehicle front-rear direction.

The slide section is moved toward the front side or rear side on the slide rail 52 by the roof motor being driven, not illustrated in the drawings, provided adjacent to the sunroof frame 32. The link mechanism section is attached to the slide section. The link mechanism section is configured by plural link members, not illustrated in the drawings, and some of the link members are attached to the sliding glass 34. The link mechanism section is operated by the roof motor being driven, and moves a rear end portion of the sliding glass 34 toward an upper side or a lower side.

In the sunroof unit 30, when opening the opening 16, the roof motor is driven to operate the link mechanism section, thereby disposing the rear end portion of the sliding glass 34 further to the upper side than a front end portion thereof, in a sloped state. The slide section then moves toward the rear side (the arrow A side), such that the sliding glass 34 is disposed in the open position above the roof panel 14, and the opening 16 is opened.

In the sunroof unit 30, when closing the opening 16, the roof motor is driven to move the slide section toward the front side. The link portion is then operated, and the rear end portion of the sliding glass 34 moves to the lower side toward the closed position, and the opening 16 is thereby closed by the sliding glass 34. As described above, the sunroof unit 30 has a structure in which the sliding glass 34 moves toward the upper side of the roof panel 14. A space 54 (see FIG. 2) is thereby formed in the sunroof unit 30, between the pair of slide rails 52, and between the center frame 42 and the roof reinforcement 44.

Roof Reinforcement

As illustrated in FIG. 2, the roof reinforcement 44 is a reinforcing member of the roof panel 14, and extends along the vehicle width direction further to a lower side than the roof panel 14, and further to the upper side than the center frame 42 and the movement section 50. Namely, the roof reinforcement 44 is formed in an elongated shape with its length direction along the vehicle width direction and its breadth direction along the vehicle front-rear direction. The roof reinforcement 44 is installed further to the vehicle cabin inside than the pair of roof side rails 18.

As illustrated in FIG. 4, the roof reinforcement 44 is formed with a rectangular waveform shaped cross-section profile running along the vehicle front-rear direction. Specifically, the roof reinforcement 44 includes three projecting portions 44A formed projecting toward the vehicle lower side with respect to an upper face, two flat portions 44B that link together the three projecting portions 44A along the vehicle front-rear direction, and flanges 44C, 44D. The three projecting portions 44A are disposed at intervals along the vehicle front-rear direction, and are each formed with a U-shaped cross-section. The flange 44C juts out toward the vehicle front side from the vehicle front side projecting portion 44A. The flange 44D juts out toward the vehicle rear side from the vehicle rear side projecting portion 44A.

As illustrated in FIG. 2, the vehicle width direction end portion of the roof reinforcement 44 is not joined to the roof side rail 18. Specifically, the roof reinforcement 44 is configured with a structure that is suspended from the roof panel 14 using spring and a coupling member, not illustrated in the drawings. Note that the vehicle width direction end portion of the roof reinforcement 44 may be joined to the roof side rail 18.

Coupling Brackets

As illustrated in FIG. 2, the coupling brackets 62, 64 couple together the center frame 42 and the roof reinforcement 44 in the vehicle up-down direction, further to the vehicle width direction inside than the movement section 50.

The coupling bracket 62 includes a plate shaped base portion 62A running along the vehicle width direction. The base portion 62A is mounted on an upper face of the flat portion 42B of the center frame 42. The vehicle width direction center position of the base portion 62A is disposed so as to be aligned in the vehicle up-down direction with the vehicle width direction center position M of the vehicle upper section 12. Namely, one coupling bracket 62 is provided along the vehicle width direction.

The base portion 62A is formed with a through-hole 62F piercing through in the vehicle up-down direction. The through-hole 62F is of a size through which the shaft portion of the bolt 43 can be inserted. Moreover, a weld nut 62G is integrally formed at a location at a peripheral edge of the through-hole 62F and at the vehicle upper side of the base portion 62A. The bolt 43 is inserted through the through-hole 42D and the through-hole 62F and is fastened to the weld nut 62G, thereby joining the base portion 62A to the upper face of the center frame 42.

Both vehicle width direction end portions of the base portion 62A are formed with a pair of upright wall portions 62B, 62C extending from the base portion 62A toward the vehicle upper side. The upright wall portions 62B, 62C respectively slope toward the vehicle width direction inside and outside with respect to the vehicle up-down direction. Namely, a cross-section profile of the coupling bracket 62 viewed along the vehicle front-rear direction is formed in a hat shape open toward an upper side. The base portion 62A and the upright wall portions 62B, 62C are an example of a main body section. Upper end portions of the upright wall portions 62B, 62C are formed with flanges 62D, 62E, serving as an example of flange portions. The flange 62D juts out from the upright wall portion 62B toward inside and the flange 62C juts out from the upright wall portion 62C toward outside in the vehicle width direction.

As illustrated in FIG. 4, the vehicle front-rear direction length of the base portion 62A is substantially the same size as the vehicle front-rear direction length of the flat portion 42B. The vehicle front-rear direction lengths of the flange 62D and the flange 62E are larger than the vehicle front-rear direction length of the base portion 62A. An upper face of the flange 62D and an upper face of the flange 62E straddle between and contact lower faces of two projecting portions 44A out of the three projecting portions 44A of the roof reinforcement 44. The flange 62D and the flange 62E are joined to the lower faces of the projecting portions 44A by spot welding.

As illustrated in FIG. 2, each coupling bracket 64 is provided above the center frame 42, and between the coupling bracket 62 and the slide rail 52 in the vehicle width direction. Namely, two of the coupling brackets 64 are provided in total, one at the left side and one at the right side of the center position M. A vehicle up-down direction height of the coupling bracket 64 is smaller than that of the coupling bracket 62, but has a similar shape to the coupling bracket 62. The same names and reference numerals as the coupling bracket 62 are accordingly used for the names and reference numerals of the respective portions of the coupling bracket 64, and explanation thereof is omitted.

A base portion 62A of the coupling bracket 64 is mounted on the flat portion 42B of the center frame 42 (see FIG. 4), and the bolt 43 is fastened to a weld nut 62G, thereby joining the coupling bracket 64 to the upper face of the center frame 42. Flanges 62D, 62E of the coupling bracket 64 are joined to the lower faces of the projecting portions 44A of the roof reinforcement 44 by spot welding. Note that the coupling brackets 62, 64 of the first exemplary embodiment are disposed open toward the upper side, the front side, and rear side, but are not open toward left and right sides in the vehicle width direction.

Assembly of Vehicle Upper Section Structure

As illustrated in FIG. 2, during assembly of the vehicle upper section structure 40, a vehicle width direction end portion of the roof panel 14 is joined onto the roof side rail 18. Next, the roof reinforcement 44 is assembled to the lower side of the roof panel 14. The flanges 62D, 62E of the coupling brackets 62, 64 are then joined to the lower side of the roof reinforcement 44. The sunroof unit 30 is then assembled in a state in which the movement section 50 is disposed at the lower side of the vehicle width direction end portion of the roof reinforcement 44.

The sunroof bracket 46 is then joined to the roof side rail 18 and the vehicle width direction end portion of the center frame 42 is joined to the sunroof bracket 46. The slide rail 52 is disposed on the center frame 42 when this is performed. Next, the center frame 42 is joined to the base portions 62A of the coupling brackets 62, 64 using the bolts 43. The coupling brackets 62, 64 are coupled to the center frame 42 and the roof reinforcement 44 in this manner, thereby forming the vehicle upper section structure 40.

Operation and Advantageous Effects

Explanation follows regarding operation and advantageous effects of the vehicle upper section structure 40 of the first exemplary embodiment.

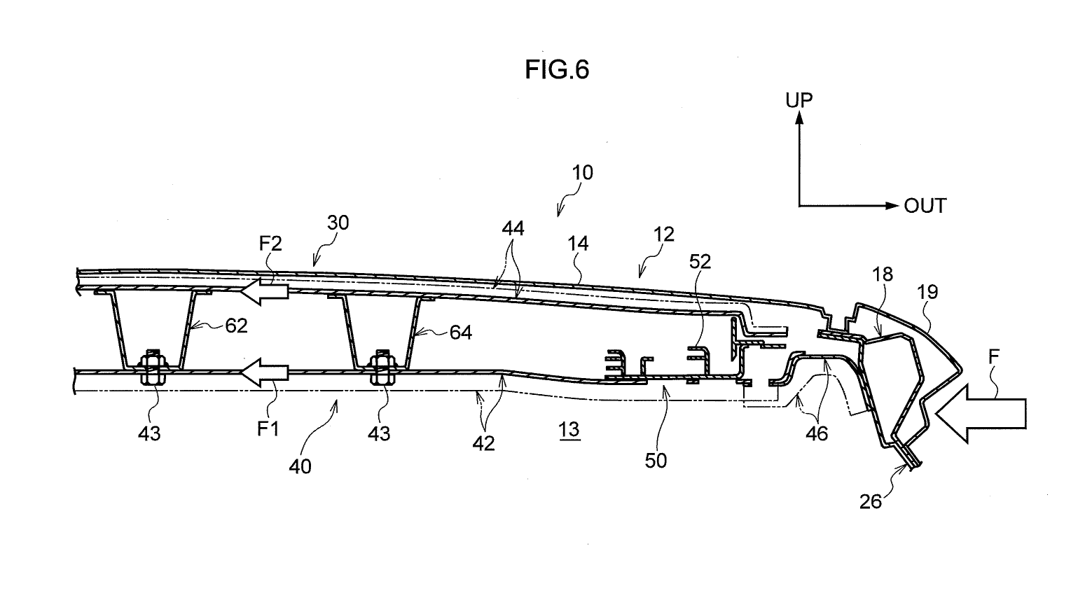

As illustrated in FIG. 6, when a load F (collision load) is input to a vehicle body side section of the vehicle 10 from the side during a side-on collision, the load F is transmitted from the center pillar 26 to the roof side rail 18, then input to the center frame 42 through the sunroof bracket 46.

Note that in the vehicle upper section structure 40, the roof reinforcement 44 is coupled to the center frame 42 through the coupling brackets 62, 64. The load F input to the center frame 42 is thereby transmitted along a first transmission path of the center frame 42 itself as a load F1, and transmitted along a second transmission path reaching the roof reinforcement 44 through the coupling brackets 62, 64, as a load F2. Namely, the load F input to the center frame 42 is distributed and effectively transmitted as the load F1 and the load F2.

In the vehicle upper section structure 40, the load F input to the vehicle body side section of the vehicle 10 is thereby distributed and transmitted as the load F1 along the first transmission path and the load F2 along the second transmission path, such that the load F is suppressed from localized concentration at a portion of the vehicle upper section 12. In the vehicle upper section structure 40, cross-section deformation of the center frame 42 and the roof reinforcement 44 is thereby suppressed compared to a configuration in which the center frame 42 and the roof reinforcement 44 are not coupled together, thereby enabling the vehicle upper section 12 to be suppressed from deforming in a side-on collision of the vehicle 10.

Note that even when the load F is input to the roof reinforcement 44 prior to the center frame 42, the load F is distributed by transmitting load to the center frame 42 through the coupling brackets 62, 64, thereby enabling the vehicle upper section 12 to be suppressed from deforming in a side-on collision.

In the vehicle upper section structure 40, the center frame 42 and the roof reinforcement 44 are coupled together by the coupling brackets 62, 64, such that there is no need to bring the center frame 42 and the roof reinforcement 44 close to each other in order to couple these members together. Namely, there is no need to curve or bend at least one of the center frame 42 or the roof reinforcement 44 in order to bring these members together, thereby enabling the center frame 42 and the roof reinforcement 44 to be formed in straight lines running along the vehicle width direction. This enables the center frame 42 and the roof reinforcement 44 to be suppressed from deforming, since there is no curved or bent location that would become a weakened portion during load transmission.

In the vehicle upper section structure 40, the front portion of the center frame 42 is disposed at the upper side of the upper end portion of the center pillar 26. A load transmission path from the center pillar 26 to the center frame 42 is thereby shorter than in a structure in which the center frame 42 is not disposed at the upper side of the center pillar 26. Load transmission efficiency from the center pillar 26 to the center frame 42 in a side-on collision is accordingly improved, thereby enabling an intrusion amount of the center pillar 26 toward the vehicle cabin 13 inside in a side-on collision to be reduced.

### Second Exemplary Embodiment

Explanation follows regarding a vehicle upper section structure 80 according to a second exemplary embodiment.

The vehicle upper section structure 80 is provided to the vehicle 10, instead of the vehicle upper section structure 40 according to the first exemplary embodiment illustrated in FIG. 1. Note that similar configuration to the first exemplary embodiment is appended with the same reference numerals, and explanation thereof is omitted as appropriate. Similar configuration is a concept including configuration that has basically the same function, although part of the length or shape may be different.

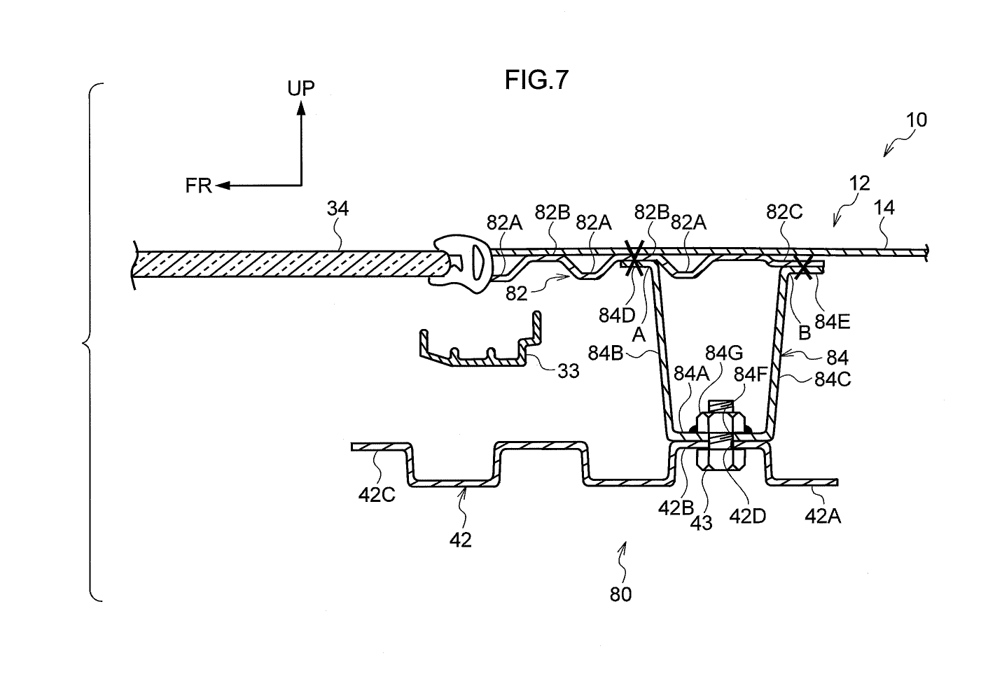

As illustrated in FIG. 7, the vehicle upper section structure 80 includes the center frame 42, roof reinforcement 82, the movement section 50 (see FIG. 2), and coupling brackets 84, each serving as an example of a coupling section and of a bracket. Note that the vehicle upper section structure 80 has a similar structure at both sides of the center position M in the vehicle width direction of the vehicle upper section 12 (see FIG. 2). Explanation thereby follows regarding the vehicle upper section structure 80 on the one vehicle width direction side (right side) and explanation of the other side (left side) is omitted. The x mark in FIG. 7 indicates a spot welded location.

Roof Reinforcement

The roof reinforcement 82 is a reinforcing member of the roof panel 14, and extends along the vehicle width direction further to the vehicle up-down direction lower side than the roof panel 14, and further to the upper side than the center frame 42 and the movement section 50 (see FIG. 2). Namely, the roof reinforcement 82 is formed in an elongated shape with its length direction along the vehicle width direction and its breadth direction along the vehicle front-rear direction. The roof reinforcement 82 is installed further to the vehicle cabin inside than the pair of roof side rails 18 (see FIG. 2).

The roof reinforcement 82 is formed with a trapezoid waveform shaped cross-section profile running along the vehicle front-rear direction. Specifically, the roof reinforcement 82 includes three projecting portions 82A formed projecting toward the vehicle lower side with respect to an upper face, two flat portions 82B that link together upper end portions of the three projecting portions 82A along the vehicle front-rear direction, and an extension portion 82C formed in a crank shape at a rear end portion of the rear side projecting portion 82A.

A vehicle width direction end portion of the roof reinforcement 82 is not joined to the roof side rail 18 (see FIG. 2), and is configured with a structure that is suspended from the roof panel 14 using a spring and a coupling member, not illustrated in the drawings. Note that the vehicle width direction end portion of the roof reinforcement 82 may be joined to the roof side rail 18.

Coupling Brackets

The coupling brackets 84 each extend with a set length along the vehicle width direction. The coupling brackets 84 are provided at three locations, including the center position M (see FIG. 2), and are provided at intervals along the vehicle width direction. The coupling brackets 84 couple together the center frame 42 and the roof reinforcement 82 further to the vehicle width direction inside than the movement section 50 (see FIG. 2).

Specifically, each coupling bracket 84 includes a plate shaped base portion 84A running along the vehicle front-rear direction. The base portion 84A is mounted on the upper face of the flat portion 42B of the center frame 42. The base portion 84A is formed with a through-hole 84F piercing through in the vehicle up-down direction. The through-hole 84F is of a size through which the shaft portion of the bolt 43 can be inserted. Moreover, a weld nut 84G is integrally formed at a location at a peripheral edge of the through-hole 84F at the vehicle upper side of the base portion 84A. The bolt 43 is inserted through the through-hole 42D and the through-hole 84F and fastened to the weld nut 84G, thereby joining the base portion 84A to the upper face of the center frame 42.

Both vehicle front-rear direction end portions of the base portion 84A are formed with a pair of upright wall portions 84B, 84C extending from the base portion 84A toward the vehicle upper side. The upright wall portions 84B, 84C respectively slope toward the front side and rear side with respect to the vehicle up-down direction. Namely, as an example, the cross-section profile of the coupling bracket 84, viewed in the vehicle width direction, is formed in a hat shape open toward the upper side. Note that the coupling bracket 84 of the second exemplary embodiment is disposed open toward the upper side, and the vehicle width direction inside and outside, but is not open toward the front side and rear side. The base portion 84A and the upright wall portions 84B, 84C are an example of a main body section. Upper end portions of the upright wall portions 84B, 84C are formed with flanges 84D, 84E, serving as an example of flange portions. The flange 84D juts out from the upright wall portion 84B toward the front side and the flange 84E juts out from the upright wall portion 84C toward the rear side.

The vehicle front-rear direction length of the base portion 84A is substantially the same size as the vehicle front-rear direction length of the flat portion 42B. The vehicle front-rear direction lengths of the flange 84D and the flange 84E are smaller than the respective vehicle front-rear direction lengths of the flat portions 82B and the extension portion 82C. An upper face of the flange 84D contacts a lower face of the rear side flat portion 82B, and an upper face of the flange 84E contacts a lower face of the extension portion 82C. The flange 84D is joined to the lower face of the flat portion 82B by spot welding, and the flange 84E is joined to the lower face of the extension portion 82C by spot welding.

Operation and Advantageous Effects

Explanation follows regarding operation and advantageous effects of the vehicle upper section structure 80 of the second exemplary embodiment.

In the vehicle upper section structure 80 illustrated in FIG. 7, when the load F is input to the vehicle body side section of the vehicle 10 during a side-on collision, the load F is input to the center frame 42 through a similar load transmission path to that in the first exemplary embodiment.

Note that in the vehicle upper section structure 80, the roof reinforcement 82 is coupled to the center frame 42 through the coupling brackets 84. The load input to the center frame 42 is thereby transmitted along a first transmission path of the center frame 42 itself, and transmitted along a second transmission path reaching the roof reinforcement 82 through the coupling brackets 84. Namely, load input to the center frame 42 is distributed and effectively transmitted as load along the first transmission path and load along the second transmission path.

In the vehicle upper section structure 80, load input to the vehicle body side section of the vehicle 10 is thereby distributed and transmitted along the first transmission path and along the second transmission path, such that load is suppressed from localized concentration at a portion of the vehicle upper section 12. In the vehicle upper section structure 80, cross-section deformation of the center frame 42 and the roof reinforcement 82 is thereby suppressed compared to a configuration in which the center frame 42 and the roof reinforcement 82 are not coupled together, thereby enabling the vehicle upper section 12 to be suppressed from deforming in a side-on collision of the vehicle 10.

Note that even when load is input to the roof reinforcement 82 prior to the center frame 42, the load is distributed by transmitting load to the center frame 42 through the coupling brackets 84, thereby enabling the vehicle upper section 12 to be suppressed from deforming in a side-on collision.

In the vehicle upper section structure 80, the center frame 42 and the roof reinforcement 82 are coupled together by the coupling brackets 84, such that there is no need to bring the center frame 42 and the roof reinforcement 82 close to each other in order to couple these members together. Namely, there is no need to curve or bend at least one of the center frame 42 or the roof reinforcement 82 in order to bring these members together, thereby enabling the center frame 42 and the roof reinforcement 82 to be formed in straight lines running along the vehicle width direction. This enables the center frame 42 and the roof reinforcement 82 to be suppressed from deforming, since there is no curved or bent location that would become a weakened portion during load transmission.

In the vehicle upper section structure 80, a ridgeline “A” that forms a boundary between the upright wall portion 84B and the flange 84D, and a ridgeline “B” that forms a boundary between the upright wall portion 84C and the flange 84E, are disposed along the vehicle width direction, this being the load transmission direction. Namely, the ridgeline direction of the coupling bracket 84 runs along the load transmission direction. The coupling brackets 84 thereby transmit load along this ridgeline direction that is not liable to deform, thereby enabling the coupling brackets 84, the center frame 42, and the roof reinforcement 82 to be suppressed from deforming. Moreover, since the coupling brackets 84 transmit load along a direction that is not liable to deform, the plate thickness of the coupling brackets 84 can be reduced. This enables the weight of the vehicle upper section structure 80 to be reduced.

Note that the present invention is not limited to the above exemplary embodiments.

Placement of the center frame 42 at the upper side of the upper end portion of the center pillar 26 is not limited to an offset placement in which respective portions overlap each other in the vehicle up-down direction as in the present exemplary embodiments, and the entire center frame 42 may be disposed directly above the center pillar 26.

The center frame 42, the roof reinforcement 44, and the coupling brackets 62, 64 are not limited to a single set in the vehicle front-rear direction as in the first exemplary embodiment, and plural sets may be provided in a row along the vehicle front-rear direction. Moreover, plural center frames 42 in a row along the vehicle front-rear direction may be joined together with single roof reinforcement 44 in the vehicle front-rear direction by coupling brackets. Alternatively, a single center frame 42 in the vehicle front-rear direction may be joined together with plural roof reinforcements 44 in a row along the vehicle front-rear direction by coupling brackets. Note that the center frame 42, the roof reinforcement 82, and the coupling brackets 84 of the second exemplary embodiment may be similarly configured by a combination of single or plural members.

The center frame 42 and the roof reinforcement 44 are not limited to rectangular waveform shaped cross-sections, and may each be formed in other shapes, such as a plate shape or a trapezoidal waveform shape. The configuration of the center frame and roof reinforcement to be employed may be selected as appropriate according to a relationship with the vehicle upper section structure, depending on vehicle type.

The coupling section coupling together the center frame and the roof reinforcement is not limited to the coupling brackets 62, 64, and 84. As another example of a coupling section, a configuration may be applied in which a bent or curved coupling section is formed at one of either the center frame or the roof reinforcement, and the coupling section is joined to the other member. As another example of a coupling section, bent or curved coupling sections may be formed to both the center frame and the roof reinforcement, and the coupling sections are joined together.

The joint method of the coupling brackets 62, 64, 84 to the center frame 42 and the roof reinforcement 44, 82 is not limited to spot welding at the upper portions and bolt fastening at the lower portions thereof, and both the upper portions and the lower portions may be joined by either spot welding or bolt fastening. Furthermore, the vehicle upper section structure is not limited to having a similar structure at both left and right sides in the vehicle width direction, and may have different structures at the right side and the left side in the vehicle width direction.

The coupling bracket 62 and the coupling bracket 64 that are open toward the vehicle front-rear direction and the coupling bracket 84 that is open toward the vehicle width direction may be used in a row in the vehicle width direction. There may either be one of each, or plural of the coupling brackets 62, 64, and 84.

The movement section 50 is not limited to moving the sliding glass 34 by sliding. For example, in a structure in which a cover member that closes the opening 16 is moved in the vehicle up-down direction by a link mechanism section, the link mechanism section is an example of a movement section.

Vehicle upper section structures according to the first exemplary embodiment and the second exemplary embodiment of the present invention have been explained above. Obviously, these exemplary embodiments may be combined and implemented as appropriate, and various embodiments may be implemented with a range not departing from the scope of the present invention.

What is claimed is:

1. A vehicle upper section structure for a vehicle having a roof panel formed with an opening, a roof side rail, a cover member for closing the opening, and a pillar joined to the roof side rail, the vehicle upper section structure comprising:
a frame that extends along a vehicle width direction further to a vehicle cabin inside than the roof panel, and further to the vehicle cabin inside than the roof side rail;
a movement section that is disposed at a vehicle width direction end portion of the frame and further to a vehicle up-down direction upper side than the frame, and that moves the cover member to an open position and to a closed position;
a roof reinforcement that extends along the vehicle width direction further to the vehicle up-down direction upper side than the frame and the movement section, and that reinforces the roof panel; and
a coupling section that couples together the frame and the roof reinforcement in the vehicle up-down direction, further to the vehicle width direction inside than the movement section.

2. The vehicle upper section structure of claim 1, wherein
the coupling section comprises a bracket that joins together a vehicle up-down direction upper face of the frame and a vehicle up-down direction lower face of the roof reinforcement.

3. The vehicle upper section structure of claim 2, wherein
the bracket includes a main body section that is open toward the vehicle width direction and is joined to the frame, and a flange portion that juts out in the vehicle front-rear direction from the main body section and is joined to the roof reinforcement.

4. The vehicle upper section structure of claim 1, wherein,
viewed along the vehicle width direction, at least a portion of the frame in the vehicle front-rear direction is disposed at an upper side in a vehicle up-down direction upper end portion of the pillar.
